(19) United States
(12) Patent Application Publication
(10) Pub. No.: US 2026/0230219 A1
(43) Pub. Date: Aug. 6, 2026

(54) PROGRESSIVE GROWING AUTOENCODER

(71) Applicant: Nokia Technologies Oy, Espoo (FI)

(72) Inventors: Sajad REZAIE, Aalborg (DK); Jie CHEN, Naperville, IL (US); Keeth Saliya Jayasinghe LADDU, Espoo (FI); Filippo TOSATO, Massy (FR)

(21) Appl. No.: 19/155,007

(22) PCT Filed: Nov. 30, 2023
(86) PCT No.: PCT/EP2023/083756

§ 371 Date: Aug. 8, 2025

(30) Foreign Application Priority Data
Feb. 17, 2023 (FI) 20235193

(51) Int. Cl. H04L 1/00; G06N 3/0455

(52) U.S. Cl. CPC H04L 1/0033; G06N 3/0455; H04L 1/0009

(57) ABSTRACT

According to an aspect, there is provided an apparatus that may be configured to obtain training data; obtain a plurality of compression rates; and train compression blocks of an encoder of an autoencoder and reconstruction blocks of a decoder of the autoencoder progressively to provide a progressive growing autoencoder based on the training data by training the first block of the encoder and the last block of the decoder to provide a first compression rate of the plurality of compression rates and then subsequently progressively training the remaining compression blocks of the encoder and the remaining reconstruction blocks of the decoder to provide respective remaining compression rates of the plurality of compression rates.

### TECHNICAL FIELD

Various example embodiments generally relate to the field of telecommunication systems. In particular, some example embodiments relate to a solution for providing a progressive growing autoencoder.

### BACKGROUND

In wireless communication networks, channel state information (CSI) is needed for precoding in multiple-input multiple-output (MIMO) communications with frequency division duplex (FDD) schemes. An accurate CSI can be used by a base station (BS) to obtain a higher signal-to-noise-ratio (SNR) and channel capacity. However, in FDD networks, only a user equipment (UE) can estimate the downlink CSI. This means that the estimated CSI needs to be shared with the base station. This in turn means that overhead is introduced to the network. To reduce the overhead, various compression and quantization methods can be used to generate a codebook that achieves a high compression rate (CR), i.e., the ratio of compressed size to uncompressed size. A lower CR thus means more compression.

As compression also requires reconstruction, an autoencoder (AE) structure may be applied in providing feedback from the UE to the BS. An encoder may generate a compressed representation of the input CSI, and a decoder may then reconstruct the CSI from the compressed representation. The CR of an AE may be determined by the network's available bandwidth and resources. However, known solutions consider a fixed-CR autoencoder. This means that multiple AE models are required to be trained, stored, and managed by gNBs and UEs. In addition, in the case of the need for sharing the gradients for training a two-sided AF model at gNB and UE, the training and sharing gradients must be repeated for every desired CR.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

According to a first aspect, an apparatus may comprise at least one processor and at least one memory storing instructions, that when executed by the at least one processor, cause the terminal apparatus to perform: obtaining training data; obtaining a plurality of compression rates; and training compression blocks of an encoder of an autoencoder and reconstruction blocks of a decoder of the autoencoder progressively to provide a progressive growing autoencoder based on the training data by training the first block of the encoder and the last block of the decoder to provide a first compression rate of the plurality of compression rates and then subsequently progressively training the remaining compression blocks of the encoder and the remaining reconstruction blocks of the decoder to provide respective remaining compression rates of the plurality of compression rates.

In an example embodiment of the first aspect, the instructions, when executed by the at least one processor, cause the terminal apparatus to perform: transmitting, to a terminal apparatus, an encoder model structure, the trained weights of the encoder, the plurality of compression rates and the required number of blocks for execution at each compression rate to enable the terminal apparatus to set the encoder model and to compress target data; selecting a compression rate to be used; and transmitting, to the terminal apparatus, an indication of the compression rate to be used.

In an example embodiment of the first aspect, the instructions, when executed by the at least one processor, Cause the terminal apparatus to perform: receiving, from the terminal apparatus, compressed target data associated with the compression rate to be used; and decompressing the compressed target data using the reconstruction blocks of the decoder corresponding to the compression rate to be used to reconstruct the target data.

In an example embodiment of the first aspect, the instructions, when executed by the at least one processor, cause the terminal apparatus to perform: selecting a new compression rate to be used; transmitting, to the terminal apparatus, an indication of the new compression rate to be used; receiving, from the terminal apparatus, compressed target data associated with the new compression rate to be used; and decompressing the compressed target data associated with the new compression rate to be used using the reconstruction blocks of the decoder corresponding to the new compression rate to be used to reconstruct the target data.

In an example embodiment of the first aspect, the instructions, when executed by the at least one processor, cause the terminal apparatus to perform: transmitting, to a base station, a decoder model structure, the trained weights of the decoder, the plurality of compression rates and the required number of blocks for execution at each compression rate to enable the base station to set the decoder model and to decompress target data; and receiving, from the base station, an indication of the compression rate to be used.

In an example embodiment of the first aspect, the instructions, when executed by the at least one processor, cause the terminal apparatus to perform: obtaining target data to be compressed; compressing the target data using the compression blocks of the encoder corresponding to the compression rate to be used to provide compressed target data; and transmitting the compressed target data to the base station.

In an example embodiment of the first aspect, the instructions, when executed by the at least one processor, cause the terminal apparatus to perform: receiving, from the base station, an indication of a new compression rate to be used; obtaining target data to be compressed; compressing the target data using the compression blocks of the encoder corresponding to the new compression rate to be used to provide compressed target data; and transmitting the compressed target data to the base station.

In an example embodiment of the first aspect, the instructions, when executed by the at least one processor, cause the terminal apparatus to perform: transmitting, to a terminal apparatus, an encoder model structure, the trained weights of the encoder, the plurality of compression rates and the required number of blocks for execution at each compression rate to enable the terminal apparatus to set the encoder model and to compress target data; and transmitting, to a base station, a decoder model structure, the trained weights of the decoder, the plurality of compression rates and the required number of blocks for execution at each compression rate to enable the base station to set the decoder model and to decompress the target data.

According to a second aspect, an apparatus may comprise at least one processor and at least one memory storing instructions, that when executed by the at least one processor, cause the terminal apparatus to perform: receiving an encoder model structure, trained weights of the encoder, a plurality of compression rates and the required number of compression blocks for execution at each compression rate; receiving, from a base station, an indication of the compression rate to be used; and setting the encoder model based on the encoder model structure, the trained weights of the encoder, the plurality of compression rates and the required number of compression blocks for execution at each compression rate.

In an example embodiment of the second aspect, the instructions, when executed by the at least one processor, cause the apparatus to perform: obtaining target data to be compressed; compressing the target data using the compression blocks of the encoder corresponding to the compression rate to be used to provide compressed target data; and transmitting the compressed target data to the base station.

In an example embodiment of the second aspect, the instructions, when executed by the at least one processor, cause the apparatus to perform: receiving, from the base station, an indication of a new compression rate to be used; obtaining target data to be compressed; compressing the target data using the compression blocks of the encoder corresponding to the new compression rate to be used to provide compressed target data; and transmitting the compressed target data to the base station.

According to a third aspect, an apparatus may comprise at least one processor and at least one memory storing instructions, that when executed by the at least one processor, cause the terminal apparatus to perform: receiving a decoder model structure, trained weights of the decoder, a plurality of compression rates and the required number of reconstruction blocks for execution at each compression rate; setting the decoder model based on the decoder model structure, the trained weights of the decoder, the plurality of compression rates and the required number of reconstruction blocks for execution at each compression rate; and transmitting, to the terminal apparatus, an indication of the compression rate to be used.

In an example embodiment of the third aspect, the instructions, when executed by the at least one processor, cause the apparatus to perform: receiving, from the terminal apparatus, compressed target data associated with the compression rate to be used; and decompressing the compressed target data using the reconstruction blocks of the decoder corresponding to the compression rate to be used to reconstruct the target data.

In an example embodiment of the third aspect, the instructions, when executed by the at least one processor, cause the apparatus to perform: transmitting, to the terminal apparatus, an indication of a new compression rate to be used; receiving, from the terminal apparatus, compressed target data associated with the new compression rate to be used; and decompressing the compressed target data using the reconstruction blocks of the decoder corresponding to the new compression rate to be used to reconstruct the target data.

According to a fourth aspect, an apparatus may comprise at least one processor and at least one memory storing instructions, that when executed by the at least one processor, cause the terminal apparatus to perform: receiving, from a base station, a plurality of compression rates; obtaining training data; training compression blocks of an encoder progressively to provide a progressive growing encoder based on the training data by training the first block of the encoder to provide a first compression rate of the plurality of compression rates and then subsequently progressively training the remaining compression blocks of the encoder to provide respective remaining compression rates of the plurality of compression rates; transmitting, to a base station, an encoder output shape and quantization output at each compression rate; and transmitting, to the base station, target data and its associated compressed target data for each training sample at each compression rate.

In an example embodiment of the fourth aspect, the instructions, when executed by the at least one processor, cause the apparatus to perform: receiving, from the base station, an indication of the compression rate to be used; obtaining target data to be compressed; compressing the target data using the compression blocks of the encoder corresponding to the compression rate to be used to provide compressed target data; and transmitting the compressed target data to the base station.

In an example embodiment of the fourth aspect, the instructions, when executed by the at least one processor, cause the apparatus to perform: receiving, from the base station, an indication of a new compression rate to be used; obtaining target data to be compressed; compressing the target data using the compression blocks of the encoder corresponding to the new compression rate to be used to provide compressed target data; and transmitting the compressed target data to the base station.

According to a fifth aspect, an apparatus may comprise at least one processor and at least one memory storing instructions, that when executed by the at least one processor, cause the terminal apparatus to perform: obtaining training data; receiving, from a terminal device, a plurality of compression rates; training reconstruction blocks of a decoder progressively to provide a progressive growing decoder based on the training data by training the last block of the decoder to provide a first compression rate of the plurality of compression rates and then subsequently progressively training the remaining reconstruction blocks of the decoder to provide respective remaining compression rates of the plurality of compression rates; transmitting, to a terminal apparatus, a decoder output shape and quantization output at each compression rate; and transmitting, to the terminal apparatus, target data and its associated compressed target data for each training sample at each compression rate.

In an example embodiment of the fifth aspect, the instructions, when executed by the at least one processor, cause the apparatus to perform: transmitting, to the terminal apparatus, an indication of the compression rate to be used; receiving, from the terminal apparatus, compressed target data associated with the compression rate to be used; and decompressing the compressed target data using the reconstruction blocks of the decoder corresponding to the compression rate to be used to reconstruct the target data.

In an example embodiment of the fifth aspect, the instructions, when executed by the at least one processor, cause the apparatus to perform: selecting a new compression rate to be used; transmitting, to the terminal apparatus, an indication of the new compression rate to be used; receiving, from the terminal apparatus, compressed target data associated with the new compression rate to be used; and decompressing the compressed target data associated with the new compression rate to be used using the reconstruction blocks of the decoder corresponding to the new compression rate to be used to reconstruct the target data.

According to a sixth aspect, an apparatus may comprise at least one processor and at least one memory storing instructions, that when executed by the at least one processor, cause the terminal apparatus to perform: obtaining a plurality of compression rates; transmitting, to a terminal device, the plurality of compression rates; receiving, from the terminal device, first data comprising an encoder output shape and quantization output at each compression rate; receiving, from the terminal device, second data comprising target data and its associated compressed target data for each training sample at each compression rate; training reconstruction blocks of a decoder progressively to provide a progressive growing decoder based on the first and the second data by training the last reconstruction block of the decoder to provide a first compression rate of the plurality of compression rates and then subsequently progressively training the remaining reconstruction blocks of the decoder to provide respective remaining compression rates of the plurality of compression rates.

In an example embodiment of the sixth aspect, the instructions, when executed by the at least one processor, cause the apparatus to perform: transmitting, to the terminal apparatus, an indication of the compression rate to be used; receiving, from the terminal apparatus, compressed target data associated with the compression rate to be used; and decompressing the compressed target data using the reconstruction blocks of the decoder corresponding to the compression rate to be used to reconstruct the target data.

In an example embodiment of the sixth aspect, the instructions, when executed by the at least one processor, cause the apparatus to perform: selecting a new compression rate to be used; transmitting, to the terminal apparatus, an indication of the new compression rate to be used; receiving, from the terminal apparatus, compressed target data associated with the new compression rate to be used; and decompressing the compressed target data associated with the new compression rate to be used using the reconstruction blocks of the decoder corresponding to the new compression rate to be used to reconstruct the target data.

According to a seventh aspect, an apparatus may comprise at least one processor and at least one memory storing instructions, that when executed by the at least one processor, cause the terminal apparatus to perform: obtaining a plurality of compression rates; transmitting the plurality of compression rates to a base station; receiving, from the base station, first data comprising a decoder output shape and quantization output at each compression rate; receiving, from the base station, second data comprising target data and its associated compressed target data for each training sample at each compression rate; training compression blocks of an encoder progressively to provide a progressive growing encoder based on the first and second data by training the first compression block of the encoder to provide a first compression rate of the plurality of compression rates and then subsequently progressively training the remaining compression blocks of the encoder to provide respective remaining compression rates of the plurality of compression rates.

In an example embodiment of the seventh aspect, the instructions, when executed by the at least one processor, cause the apparatus to perform: receiving, from the base station, an indication of the compression rate to be used; obtaining target data to be compressed; compressing the target data using the compression blocks of the encoder corresponding to the compression rate to be used to provide compressed target data; and transmitting the compressed target data to the base station.

In an example embodiment of the seventh aspect, the instructions, when executed by the at least one processor, cause the apparatus to perform: receiving, from the base station, an indication of a new compression rate to be used; obtaining target data to be compressed; compressing the target data using the compression blocks of the encoder corresponding to the new compression rate to be used to provide compressed target data; and transmitting the compressed target data to the base station.

According to an eighth aspect, a method may comprise obtaining training data; obtaining a plurality of compression rates; and training compression blocks of an encoder of an autoencoder and reconstruction blocks of a decoder of the autoencoder progressively to provide a progressive growing autoencoder based on the training data by training the first block of the encoder and the last block of the decoder to provide a first compression rate of the plurality of compression rates and then subsequently progressively training the remaining compression blocks of the encoder and the remaining reconstruction blocks of the decoder to provide respective remaining compression rates of the plurality of compression rates.

According to a ninth aspect, a method may comprise receiving an encoder model structure, trained weights of the encoder, a plurality of compression rates and the required number of compression blocks for execution at each compression rate; receiving, from a base station, an indication of the compression rate to be used; and setting the encoder model based on the encoder model structure, the trained weights of the encoder, the plurality of compression rates and the required number of compression blocks for execution at each compression rate.

According to a tenth aspect, a method may comprise receiving a decoder model structure, trained weights of the decoder, a plurality of compression rates and the required number of reconstruction blocks for execution at each compression rate; setting the decoder model based on the decoder model structure, the trained weights of the decoder, the plurality of compression rates and the required number of reconstruction blocks for execution at each compression rate; and transmitting, to the terminal apparatus, an indication of the compression rate to be used.

According to an eleventh aspect, a method may comprise receiving, from a base station, a plurality of compression rates; obtaining training data; training compression blocks of an encoder progressively to provide a progressive growing encoder based on the training data by training the first block of the encoder to provide a first compression rate of the plurality of compression rates and then subsequently progressively training the remaining compression blocks of the encoder to provide respective remaining compression rates of the plurality of compression rates; transmitting, to a base station, an encoder output shape and quantization output at each compression rate; and transmitting, to the base station, target data and its associated compressed target data for each training sample at each compression rate.

According to a twelfth aspect, a method may comprise obtaining training data; receiving, from a terminal device, a plurality of compression rates; training reconstruction blocks of a decoder progressively to provide a progressive growing decoder based on the training data by training the last block of the decoder to provide a first compression rate of the plurality of compression rates and then subsequently progressively training the remaining reconstruction blocks of the decoder to provide respective remaining compression rates of the plurality of compression rates; transmitting, to a terminal apparatus, a decoder output shape and quantization output at each compression rate; and transmitting, to the terminal apparatus, target data and its associated compressed target data for each training sample at each compression rate.

According to a thirteenth aspect, a method may comprise obtaining a plurality of Compression rates; transmitting, to a terminal device, the plurality of compression rates; receiving, from a terminal device, first data comprising an encoder output shape and quantization output at each compression rate; receiving, from the terminal device, second data comprising target data and its associated compressed target data for each training sample at each compression rate; training reconstruction blocks of a decoder progressively to provide a progressive growing decoder based on the first and the second data by training the last reconstruction block of the decoder to provide a first compression rate of the plurality of compression rates and then subsequently progressively training the remaining reconstruction blocks of the decoder to provide respective remaining compression rates of the plurality of compression rates.

According to a fourteenth aspect, a method may comprise obtaining a plurality of compression rates; transmitting the plurality of compression rates to a base station; receiving, from the base station, first data comprising a decoder output shape and quantization output at each compression rate; receiving, from the base station, second data comprising target data and its associated compressed target data for each training sample at each compression rate; training compression blocks of an encoder progressively to provide a progressive growing encoder based on the first and second data by training the first compression block of the encoder to provide a first compression rate of the plurality of compression rates and then subsequently progressively training the remaining compression blocks of the encoder to provide respective remaining compression rates of the plurality of compression rates.

According to a fifteenth aspect a computer program comprises instructions for causing an apparatus to carry out the method of any of the eighth to fourteenth aspect.

According to a sixteenth aspect a computer readable medium comprises a computer program comprising instructions for causing an apparatus to carry out the method of any of the eighth to fourteenth aspect.

According to a seventeenth aspect, an apparatus may comprise means for: obtaining training data; obtaining a plurality of compression rates; and training compression blocks of an encoder of an autoencoder and reconstruction blocks of a decoder of the autoencoder progressively to provide a progressive growing autoencoder based on the training data by training the first block of the encoder and the last block of the decoder to provide a first compression rate of the plurality of compression rates and then subsequently progressively training the remaining compression blocks of the encoder and the remaining reconstruction blocks of the decoder to provide respective remaining compression rates of the plurality of compression rates.

According to a eighteenth aspect, an apparatus may comprise means for: receiving an encoder model structure, trained weights of the encoder, a plurality of compression rates and the required number of compression blocks for execution at each compression rate; receiving, from a base station, an indication of the compression rate to be used; and setting the encoder model based on the encoder model structure, the trained weights of the encoder, the plurality of compression rates and the required number of compression blocks for execution at each compression rate.

According to a nineteenth aspect, an apparatus may comprise means for: receiving, from a terminal apparatus, a decoder model structure, trained weights of the decoder, a plurality of compression rates and the required number of reconstruction blocks for execution at each compression rate; setting the decoder model based on the decoder model structure, the trained weights of the decoder, the plurality of compression rates and the required number of reconstruction blocks for execution at each compression rate; and transmitting, to the terminal apparatus, an indication of the compression rate to be used.

According to a twentieth aspect, an apparatus may comprise means for: receiving, from a base station, a plurality of compression rates; obtaining training data; training compression blocks of an encoder progressively to provide a progressive growing encoder based on the training data by training the first block of the encoder to provide a first compression rate of the plurality of compression rates and then subsequently progressively training the remaining compression blocks of the encoder to provide respective remaining compression rates of the plurality of compression rates; transmitting, to a base station, an encoder output shape and quantization output at each compression rate; and transmitting, to the base station, target data and its associated compressed target data for each training sample at each compression rate.

According to a twenty-first aspect, an apparatus may comprise means for: obtaining training data; receiving, from a terminal device, a plurality of compression rates; training reconstruction blocks of a decoder progressively to provide a progressive growing decoder based on the training data by training the last block of the decoder to provide a first compression rate of the plurality of compression rates and then subsequently progressively training the remaining reconstruction blocks of the decoder to provide respective remaining compression rates of the plurality of compression rates; transmitting, to a terminal apparatus, a decoder output shape and quantization output at each compression rate; and transmitting, to the terminal apparatus, target data and its associated compressed target data for each training sample at each compression rate.

According to a twenty-second aspect, an apparatus may comprise means for: obtaining a plurality of compression rates; transmitting, to a terminal device, the plurality of compression rates; receiving, from a terminal device, first data comprising an encoder output shape and quantization output at each compression rate; receiving, from the terminal device, second data comprising target data and its associated compressed target data for each training sample at each compression rate; training reconstruction blocks of a decoder progressively to provide a progressive growing decoder based on the first and the second data by training the last reconstruction block of the decoder to provide a first compression rate of the plurality of compression rates and then subsequently progressively training the remaining reconstruction blocks of the decoder to provide respective remaining compression rates of the plurality of compression rates.

According to a twenty-third aspect, an apparatus may comprise means for: obtaining a plurality of compression rates; transmitting the plurality of compression rates to a base station; receiving, from the base station, first data comprising a decoder output shape and quantization output at each compression rate; receiving, from the base station, second data comprising target data and its associated compressed target data for each training sample at each compression rate; training compression blocks of an encoder progressively to provide a progressive growing encoder based on the first and second data by training the first compression block of the encoder to provide a first compression rate of the plurality of compression rates and then subsequently progressively training the remaining compression blocks of the encoder to provide respective remaining compression rates of the plurality of compression rates.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a method according to an example embodiment.

FIG. 2A illustrates a block-wise progressive training of an autoencoder according to an example embodiment.

FIG. 2B illustrates a fade in technique for a progressive growing autoencoder according to an example embodiment.

FIG. 3 illustrates an example of a method according to an example embodiment.

FIG. 4 illustrates an example of a method according to an example embodiment.

FIG. 5 illustrates an example of a method according to an example embodiment.

FIG. 6 illustrates an example of a method according to an example embodiment.

FIG. 7 illustrates an example of a method according to an example embodiment.

FIG. 8 illustrates an example of a method according to an example embodiment.

FIG. 9 illustrates a flow diagram according to an example embodiment.

FIG. 10 illustrates a flow diagram according to an example embodiment.

FIG. 11 illustrates a flow diagram according to an example embodiment.

FIG. 12 illustrates a flow diagram according to an example embodiment.

FIG. 13 illustrates a communication system applying a progressive growing autoencoder framework according to an example embodiment.

FIG. 14 illustrates an example of an apparatus configured to practice one or more example embodiments.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms, in which the present example may be constructed or utilized. The description sets forth the functions of the example and the sequence of steps for constructing and operating the example. However, the same or equivalent functions and sequences may be accomplished by different examples.

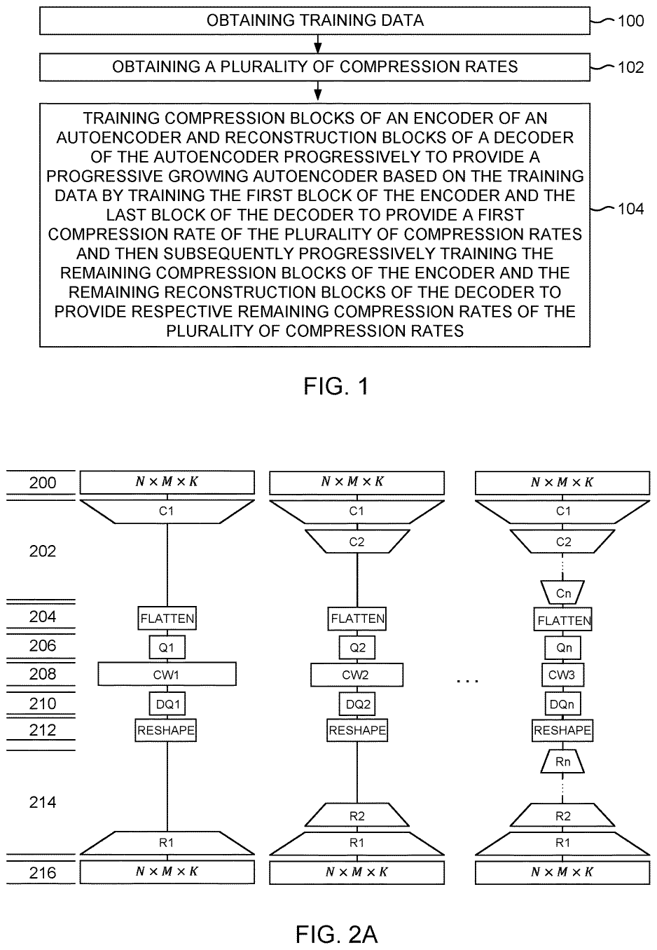

FIG. 1 illustrates an example of a method according to an example embodiment. The method may be performed, for example, by a base station (BS), a user equipment (UE) of a cloud node.

At 100, training data is obtained. The training data comprises, for example, at least one of estimated channel state information (CSI) by the UE, a set of valid compression rates (CR), and compressed CSIs with all the valid CRs.

At 102, a plurality of CRs is obtained. A CR refers to the ratio of compressed size to uncompressed size. In an example embodiment, the CRs may be arranged in a list in a descending order (i.e., CR1>CR2> . . . CRn).

At 104, an autoencoder is trained progressively so that compression blocks of an encoder of an autoencoder and reconstruction blocks of a decoder of the autoencoder are trained progressively to provide a progressive growing autoencoder based on the training data. The first block of the encoder and the last block of the decoder are trained to provide a first compression rate of the plurality of compression rates. Then, the remaining compression blocks of the encoder and the remaining reconstruction blocks of the decoder are subsequently progressively trained to provide respective remaining compression rates of the plurality of compression rates. In other words, the second block of the encoder and the second last block of the decoder are trained to provide a second compression rate of the plurality of compression rates. The procedure is continued until the last block of the encoder and the first block of the decoder have been trained to provide the last compression rate of the plurality of compression rates.

In an example embodiment, depending on a target CR when deploying the autoencoder, the UE uses the first B blocks of the encoder and the base station uses the last B blocks of the decoder, where B corresponds to the location of the target CR in the CR list.

In an example embodiment, the autoencoder may be trained progressively according to the following pseudocode.
Initialize compression list CR_list=[CR₁, CR₂, . . . , CR_{N}]
Design N blocks in the encoder (C₁, C₂, . . . , C_{N}) to support the CR_list
Design N blocks in the decoder (R₁, R₂, . . . , R_{N}) to support the CR_list
For i=1, N do
   Add block Cᵢ to the encoder
   Add block Rᵢ to the decoder
   Train the autoencoder
   Freeze the trained parameters of the blocks Cᵢ and Rᵢ
End for

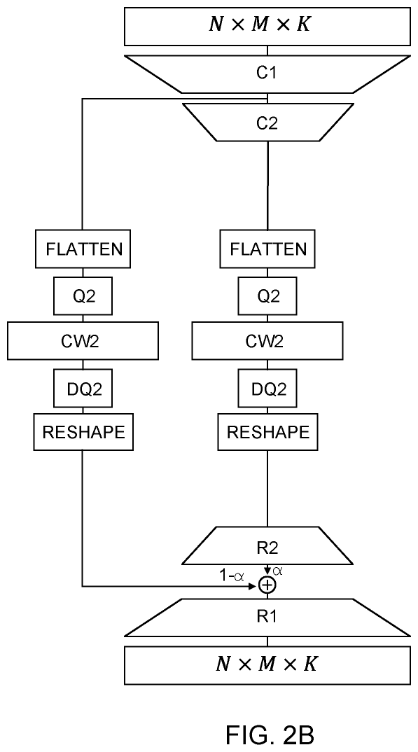

FIG. 2A illustrates the block-wise progressive training of an autoencoder according to an example embodiment. In this example, channel state information (CSI) 200 is compressed to a codeword and the reconstructed back to reconstructed CSI 216.

In the example illustrated in FIG. 2A, several compression blocks C1, C2, . . . , Cn 200 and reconstruction blocks R1, R2, . . . , Rn 214 are trained progressively. The procedure may involve flattening 204, quantization 206, dequantization 210 and reshaping 212. After the compression, a codeword 218 is provided. Each compression block or reconstruction block may use only fully connected layer(s), only convolutional layer(s), Transformer model(s), or combination of these layers. Each compression block or reconstruction block may include one or more layers. Although FIG. 2A illustrates a 3D CSI input as an example, for example a spatial-frequency-temporal CSI input, in other example embodiments, the illustrated solution can work with any dimensionality of CSI as an input.

In an example embodiment, the implementation of the discussed progressively trained autoencoder may depend, for example, on bit/scalar/vector quantization and on the choice of freezing or fine tuning the previously trained blocks in the training progress phase. If vector quantization is considered for the quantization of encoder outputs, it is necessary to define a specific set of quantization codewords at each stage of progressive training. In this case, all the obtained quantization codebooks are shared with the UE, and the UE uses the proper codebook according to the target CR.

In the scalar quantization, fewer bits are used to represent each entry of the encoder output, which includes uninform and non-uniform quantization methods. On the other hand, vector quantization considers the correlation between entries of the encoder output. In this approach, the quantization error may be minimized by finding the optimal quantization centers in a multi-dimensional space. In the illustrated solution, different vector quantization blocks are needed for each stage of the training procedure.

FIG. 2B illustrates a fade in technique for a progressive growing autoencoder according to an example embodiment.

In the i-th stage of the progressively training procedure, the compression block Ci and reconstruction block Ri are the target encoder and decoder training blocks. All the already well-trained encoder blocks {C1, C2, . . . , Ci-1} and decoder blocks {R1, R2, . . . , Ri-1} are either
a) freezed, i.e., the weights of these blocks are not updated,
b) fine-tuned, i.e., the weights of these blocks are part of the training procedure in the i-th stage.

The option a) guaranties the performance of the autoencoder for the previous CRs, while providing an acceptable performance for the target CRi. However, this choice may lead to performance degradation compared to the performance with option b).

On the other hand, having all the parameters in the training list at the option b) may result in severe performance degradation for the previously trained CRs. After each training stage, it is necessary to evaluate the performance of the progressive growing autoencoder for all the previous {CRs, CR1, CR2, . . . CRi-1}. If the performance for any of the previous CRs is dropped, the i-th stage of the training procedure needs to be repeated by following the option a).

For the option b), to prevent abrupt shocks to the previously well-trained blocks, the fade in technique can be used. As illustrated in FIG. 2B, a weighted bypass branch is added to control the effects of the target blocks on the loss function and smoothly fade in the target blocks. At each stage of the training procedure and during the training of the target compression and reconstruction blocks, a is gradually increased from 0 to 1 to fade the new blocks in smoothly. In the example illustrated in FIG. 2B, we fade in the blocks C2 and R2 in the ML model by gradually increasing α from 0 to 1.

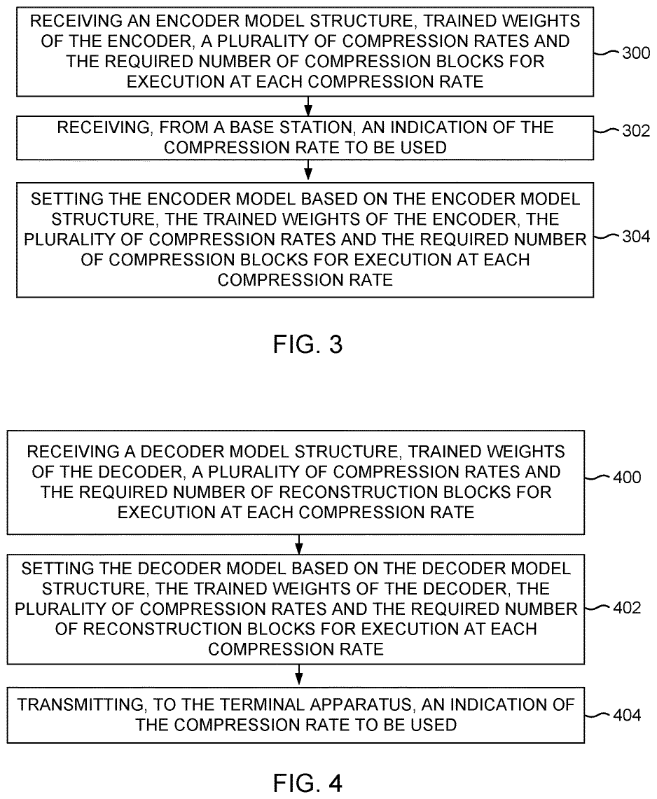

FIG. 3 illustrates an example of a method according to an example embodiment. The method may be implemented by a terminal apparatus, for example, user equipment (UE) wirelessly connected to a network apparatus, for example, a base station or a gNB.

At 300, the UE may receive an encoder model structure, trained weights of the encoder, a plurality of compression rates and the required number of compression blocks for execution at each compression rate. This information may be received, for example, from a base station, a gNB or a cloud node that has trained an autoencoder based on the progressive training procedure discussed in FIGS. 1, 2A and 2B.

At 302, the UE may receive from a base station an indication of the compression rate to be used.

At 304, the UE may set the encoder model based on the encoder model structure, the trained weights of the encoder, the plurality of compression rates and the required number of compression blocks for execution at each compression rate. After this, the UE is able to compress target data with the encoder. The target data comprises, for example, channel state information (CSI). In other example embodiments, also other data types can be used, for example, image data or any other data that needs to be compressed by the UE and then decompressed/reconstructed by the gNB.

FIG. 4 illustrates an example of a method according to an example embodiment. The method may be implemented by a base station, for example, a gNB.

At 400, the gNB may receive a decoder model structure, trained weights of the decoder, a plurality of compression rates and the required number of reconstruction blocks for execution at each compression rate. This information may be received, for example, from a UE or a cloud node that has trained an autoencoder based on the progressive training procedure discussed in more detail in FIGS. 1, 2A and 2B and their description.

At 402, the gNB may set the decoder model based on the decoder model structure, the trained weights of the decoder, the plurality of compression rates and the required number of reconstruction blocks for execution at each compression rate. After this, the gNB is able to reconstruct compressed target data with the encoder.

At 404, the gNB may transmit to the UE an indication of the compression rate to be used.

The target data comprises, for example, channel state information (CSI). In other example embodiments, also other data types can be used, for example, image data or any other data that needs to be compressed by the UE and then decompressed/reconstructed by the gNB.

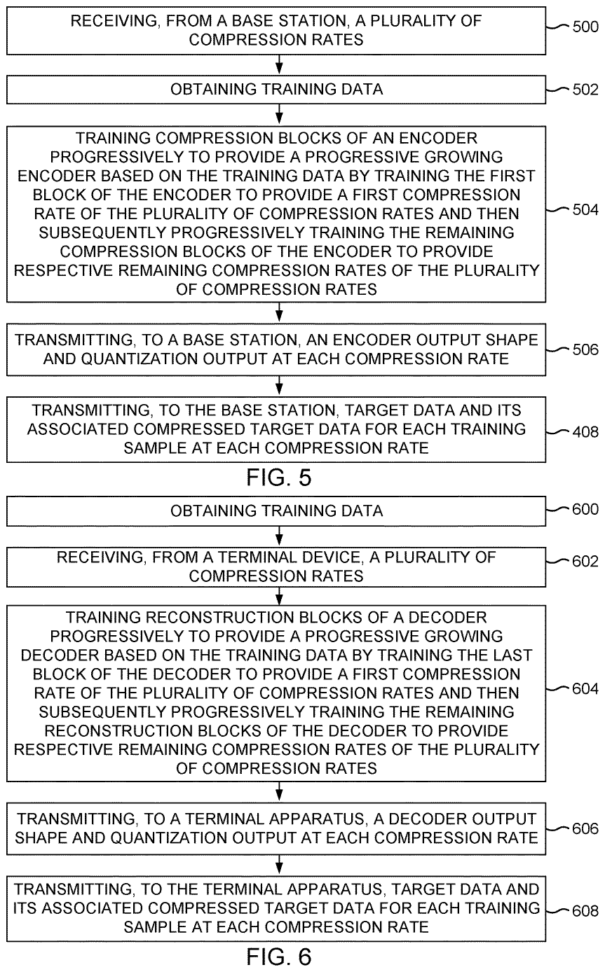

FIG. 5 illustrates an example of a method according to an example embodiment. The method may be implemented by a UE, when the UE trains the encoder first and the gNB then trains the decoder.

At 500, the UE may receive from the gNB a plurality of compression rates.

At 502, the UE may obtain training data to train the encoder.

At 504, the UE may train compression blocks of the encoder progressively to provide a progressive growing encoder based on the training data by training the first block of the encoder to provide a first compression rate of the plurality of compression rates and then subsequently progressively training the remaining compression blocks of the encoder to provide respective remaining compression rates of the plurality of compression rates. The training has been discussed in more detail in FIGS. 1, 2A and 2B and their description.

At 506, the UE may transmitting to the gNB an encoder output shape and quantization output at each compression rate.

At 508, the UE may transmit to the base station target data and its associated compressed target data for each training sample at each compression rate. With the data transmitted at steps 506, 508, the gNB is able to train a decoder.

FIG. 6 illustrates an example of a method according to an example embodiment. The method may be implemented by the gNB, when the gNB first trains the decoder and the UE then trains the encoder.

At 600, the gNB may obtain training data.

At 602, the gNB may receive from the UE a plurality of compression rates.

At 604, the gNB may train reconstruction blocks of the decoder progressively to provide a progressive growing decoder based on the training data by training the last block of the decoder to provide a first compression rate of the plurality of compression rates and then subsequently progressively training the remaining reconstruction blocks of the decoder to provide respective remaining compression rates of the plurality of compression rates. The training has been discussed in more detail in FIGS. 1, 2A and 2B and their description.

At 606, the gNB may transmit to the UE a decoder output shape and quantization output at each compression rate.

At 608, the gNB may transmit to the UE target data and its associated compressed target data for each training sample at each compression rate. With the data transmitted at steps 606, 608, the UE is able to train an encoder.

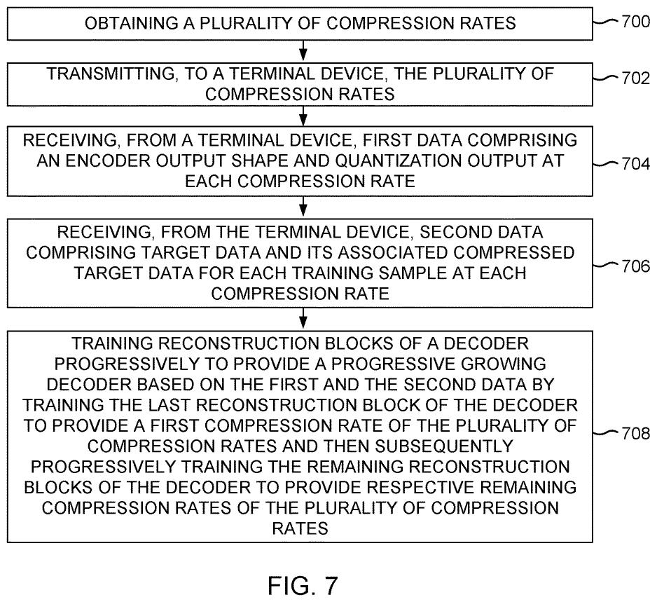

FIG. 7 illustrates an example of a method according to an example embodiment. The method may be implemented by the gNB, when the UE trains the encoder first and the gNB then trains the decoder.

At 700, the gNB may obtain a plurality of compression rates.

At 702, the gNB may transmit to the UE the plurality of compression rates.

At 704, the gNB may receive, from the UE, first data comprising an encoder output shape and quantization output at each compression rate.

At 706, the gNB may receive, from the UE, second data comprising target data and its associated compressed target data for each training sample at each compression rate.

At 708, the gNB may train reconstruction blocks of the decoder progressively to provide a progressive growing decoder based on the first and the second data by training the last reconstruction block of the decoder to provide a first compression rate of the plurality of compression rates and then subsequently progressively training the remaining reconstruction blocks of the decoder to provide respective remaining compression rates of the plurality of compression rates. The training has been discussed in more detail in FIGS. 1, 2A and 2B and their description.

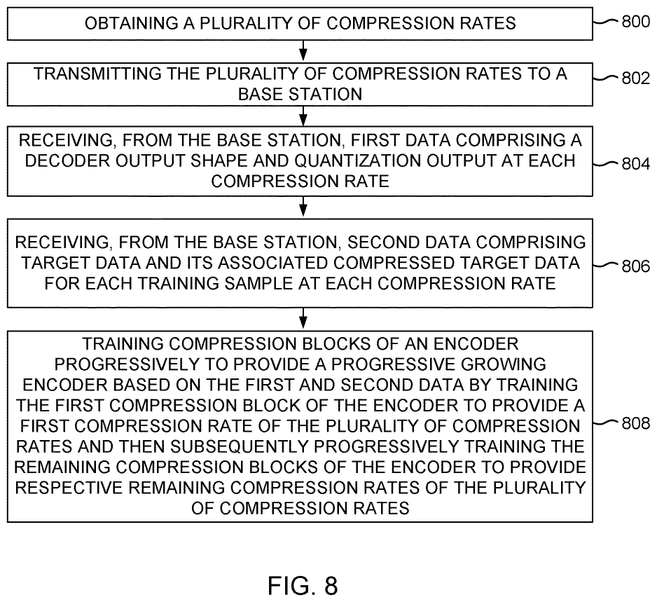

FIG. 8 illustrates an example of a method according to an example embodiment. The method may be implemented by the UE, when the gNB trains the decoder first and the UE then trains the encoder.

At 800, the UE may obtain a plurality of compression rates.

At 802, the UE may transmit the plurality of compression rates to the gNB.

At 804, the UE may receive, from the gNB, first data comprising a decoder output shape and quantization output at each compression rate.

At 806, the UE may receive, from the gNB, second data comprising target data and its associated compressed target data for each training sample at each compression rate.

At 808, the UE may train compression blocks of an encoder progressively to provide a progressive growing encoder based on the first and second data by training the first compression block of the encoder to provide a first compression rate of the plurality of compression rates and then subsequently progressively training the remaining compression blocks of the encoder to provide respective remaining compression rates of the plurality of compression rates. The training has been discussed in more detail in FIGS. 1, 2A and 2B and their description.

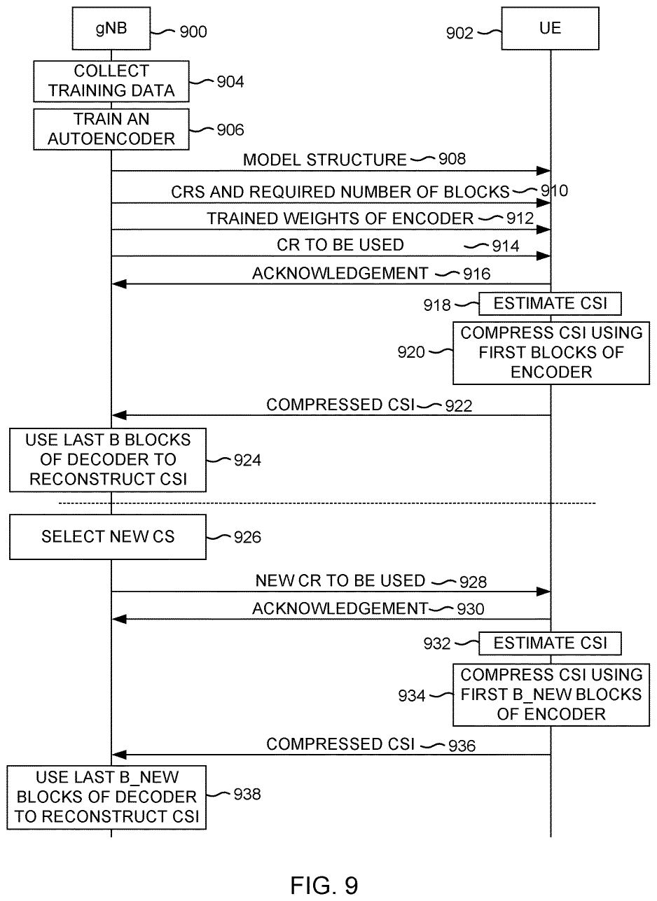

FIG. 9 illustrates a flow diagram according to an example embodiment. FIG. 9 illustrates an example in which an autoencoder is trained progressively by a single entity, i.e. by a gNB 900. In other words, both the encoder and the decoder are trained progressively at the gNB side.

At 904 the gNB is configured to collect the necessary training data for training the autoencoder, and at 906 train the autoencoder based on the training data. At 908, the gNB 900 then transmits the encoder model structure and trained weights to the UE 902. In an example embodiment, when the network is trained progressively, the gNB 900 may set Prog_Train=1, which informs the UE about the option of using a single network for different CRS:
Prog_Train=0 means the ML model is trained in a traditional end to end scheme for a fixed CR. This means that the network cannot be used for several CRs.
Prog_Train=1 means that progressive training is used for training of the ML model, and it supports several CRs.

At 910, the gNB 900 is configured to transmit to the UE 902 a list of CRs and the required number of blocks. At 912, the gNB 900 is configured to transmit to the UE 902 the trained weights of the encoder, which can be used for several CRs. At 914, the gNB 900 is configured to transmit to the UE 902 an indication of the CR to be used. In an example embodiment, at 916, the UE 902 may be configured to transmit an acknowledgement to the gNB 900. The acknowledgement confirms that the UE 902 has received all the necessary information and is ready to use the encoder. The UE 902 may use the received model structure and training weights to set the encoder model. Instead of sending an explicit acknowledgement, the UE 902 may wait for a pre-defined time before using the encoder model.

At 918, the UE 902 may be configured to estimate channel state information (CSI), and at 920, compress the CSI using the first B blocks of the encoder. The parameter B is defined by the CR applied. At 922, the UE 902 may be configured to transmit the compressed CSI to the gNB 900. At 924, the gNB 900 may be configured to use the last B blocks of the decoder to reconstruct the CSI.

At some point of time, at 926, the gNB 900 may be configured to select a new CR from the list of CRs. At 928, the gNB 900 is configured to transmit to the UE 902 an indication of the new CR to be used. In an example embodiment, at 930, the UE 902 may be configured to transmit an acknowledgement to the gNB 900. The acknowledgement confirms that the UE 902 has received all the necessary information and is ready to use the encoder. Instead of sending an explicit acknowledgement, the UE 902 may wait for a pre-defined time before using applying the new CR. At any point, if the gNB 900 decides to change the CR, there is no need to share the network and its weights again, as the previous shared network can be used for the new CR. Thus, the gNB sends the required new number of encoder blocks, B_New, to the UE 902, and the UE 902 adapts the encoder active part accordingly.

At 932, the UE 902 may be configured to estimate the CSI, and at 934, compress the CSI using the first B_New blocks of the encoder. The parameter B_New is defined by the CR applied. At 936, the UE 902 may be configured to transmit the compressed CSI to the gNB 900. At 938, the gNB 900 may be configured to use the last B_New blocks of the decoder to reconstruct the CSI.

FIG. 9 illustrates an example in which the gNB 900 trains the autoencoder. In another example embodiment, the autoencoder may be trained by the UE 902, and thus the steps 904-912 may be performed by the UE 902.

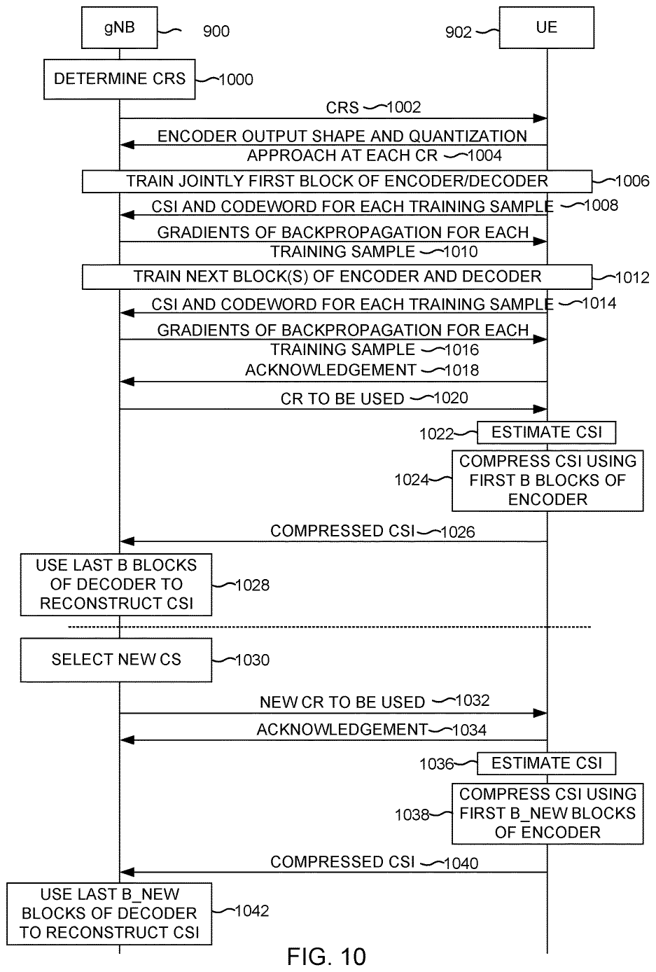

FIG. 10 illustrates a flow diagram according to an example embodiment. FIG. 10 illustrates an example in which both sides, i.e. the gNB 900 and the UE 902, take part in the progressive training. The training includes sharing of information, including CSIs and codewords from the encoder side and backward gradients from the decoder side.

At 1000, the gNB 900 is configured to determine the list of CRs, and at 1002, transmit the CRs to the UE 902. At 1004, the US 902 is configured to transmit the output shape of the encoder at each CR. At 1006-1010, the gNB 900 and the UE 902 respectively train the first block of the encoder and the last block of the decoder by sharing the CSI, codeword, and the backward gradients for each training sample. At 1012-1016 the gNB 900 and the UE 902 continue the procedure to progressively train the remaining blocks of the autoencoder.

In an example embodiment, at 1018, the UE 902 may be configured to transmit an acknowledgement to the gNB 900. The acknowledgement confirms that the UE 902 has received all the necessary information and is ready to use the encoder. Instead of sending an explicit acknowledgement, the UE 902 may wait for a pre-defined time before using the encoder model. At 1020, the gNB 900 may be configured to transmit the CR to be used to the UE 902.

At 1022, the UE 902 may be configured to estimate channel state information (CSI), and at 1024, compress the CSI using the first B blocks of the encoder. The parameter B is defined by the CR applied. At 1026 the UE 902 may be configured to transmit the compressed CSI to the gNB 900. At 1028, the gNB 900 may be configured to use the last B blocks of the decoder to reconstruct the CSI.

At some point of time, at 1030, the gNB 900 may be configured to select a new CR from the list of CRs. At 1032, the gNB 900 is configured to transmit to the UE 902 an indication of the new CR to be used. In an example embodiment, at 1034, the UE 902 may be configured to transmit an acknowledgement to the gNB 900. The acknowledgement confirms that the UE 902 has received all the necessary information and is ready to use the encoder. Instead of sending an explicit acknowledgement, the UE 902 may wait for a pre-defined time before using applying the new CR. At any point, if gNB 900 decides to change the CR, there is no need to share the network and its weights again, as the previous shared network can be used for the new CR. Thus, the gNB sends the required new number of encoder blocks, B_New, to the UE 902, and the UE 902 adapts the encoder active part accordingly.

At 1036, the UE 902 may be configured to estimate the CSI, and at 1038, compress the CSI using the first B_New blocks of the encoder. The parameter B_New is defined by the CR applied. At 1040, the UE 902 may be configured to transmit the compressed CSI to the gNB 900. At 1042, the gNB 900 may be configured to use the last B_New blocks of the decoder to reconstruct the CSI.

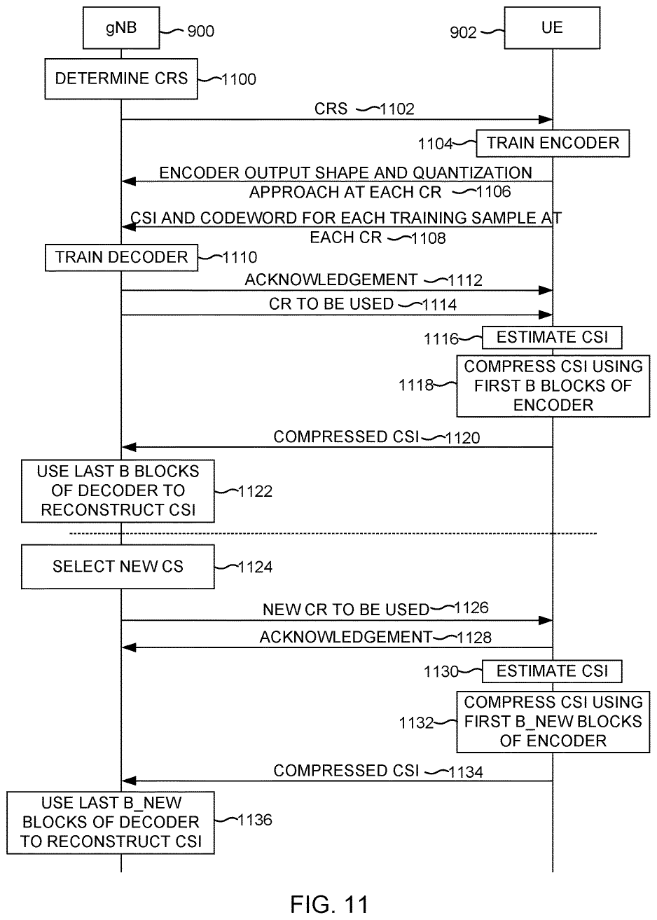

FIG. 11 illustrates a flow diagram according to an example embodiment. FIG. 11 illustrates an example in which both sides, i.e. the gNB 900 and the UE 902, take part in the progressive training. The UE 902 is configured to first train the encoder and the gNB 900 trains the decoder after that.

At 1100, the gNB 900 is configured to determine the list of CRs, and at 1102, transmit the CRs to the UE 902. In an example embodiment, when the network is trained progressively, the gNB 900 may set Prog_Train=1, which informs the UE 902 about the option of using a single network for different CRs:
Prog_Train=0 means the ML model is trained in a traditional end to end scheme for a fixed CR. This means that the network cannot be used for several CRs.
Prog_Train=1 means that progressive training is used for training of the ML model, and it supports several CRS.

At 1104, the UE 902 is configured to train the encoder based on training data. The UE 902 may be configured to transmit the output shape of the encoder and a quantization approach at each CR. At 1108, the UE 902 may be configured to transmit the training data (e.g., the CSI and the codeword) used in training the encoder with a given CR, to the gNB 900 directly or via a remote server such that qNB can download the same training data set for decoder training. The training data may be corresponding to different CRs as well.

At 1110, the gNB 900 may be configured to train the decoder based on the training data. In an example embodiment, at 1112, the gNB 900 may be configured to transmit an acknowledgement to the UE 902. The acknowledgement confirms that the gNB 900 has received all the necessary information and is ready to use the decoder. Instead of waiting for an explicit acknowledgement, the UE 902 may wait for a pre-defined time before using the encoder model. At 1114, the gNB 900 may be configured to transmit the CR to be used to the UE 902.

At 1116, the UE 902 may be configured to estimate channel state information (CSI), and at 1118, compress the CSI using the first B blocks of the encoder. The parameter B is defined by the CR applied. At 1120, the UE 902 may be configured to transmit the compressed CSI to the gNB 900. At 1122, the gNB 900 may be configured to use the last B blocks of the decoder to reconstruct the CSI.

At some point of time, at 1124, the gNB 900 may be configured to select a new CR from the list of CRs. At 1126, the gNB 900 is configured to transmit to the UE 902 an indication of the new CR to be used. In an example embodiment, at 1128, the UE 902 may be configured to transmit an acknowledgement to the gNB 900. The acknowledgement confirms that the UE 902 has received all the necessary information and is ready to use the encoder. Instead of sending an explicit acknowledgement, the UE 902 may wait for a pre-defined time before using applying the new CR. At any point, if gNB 900 decides to change the CR, there is no need to share the network and its weights again, as the previous shared network can be used for the new CR. Thus, the gNB sends the required new number of encoder blocks, B_New, to the UE 902, and the UE 902 adapts the encoder active part accordingly.

At 1130, the UE 902 may be configured to estimate the CSI, and at 1132, compress the CSI using the first B_New blocks of the encoder. The parameter B_New is defined by the CR applied. At 1134, the UE 902 may be configured to transmit the compressed CSI to the gNB 900. At 1136, the gNB 900 may be configured to use the last B_New blocks of the decoder to reconstruct the CSI.

FIG. 11 illustrates an example in which the encoder is trained first. In another example embodiment, the decoder may be trained first by the gNB 900.

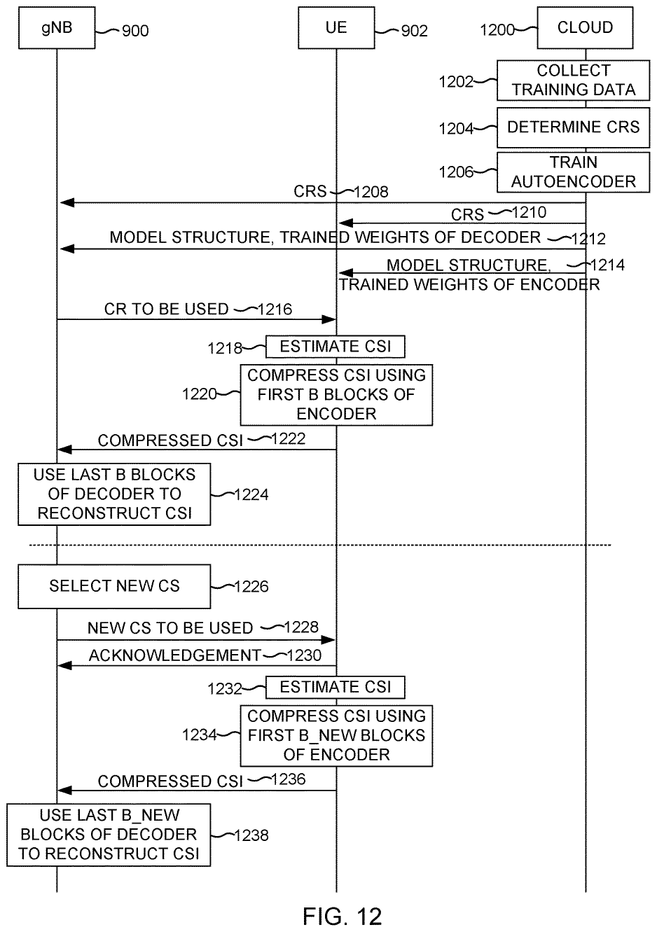

FIG. 12 illustrates a flow diagram according to an example embodiment. FIG. 12 illustrates an example in which an autoencoder is trained progressively by a single entity, i.e. by a cloud node 1200. In other words, both the encoder and the decoder are trained progressively by the cloud node 1200.

At 1202 the cloud node 1200 is configured to collect the necessary training data for training the autoencoder. At 1204, the cloud node 1200 is configured to determine the list of CRs and at 1206 train the autoencoder based on the training data. At 1208, the cloud node 1200 then transmits the CRs to the gNB and at 1210 to the UE 902. At 1212 the cloud node 1200 is configured to transmit the decoder model structure and the trained weights to the gNB 900. At 1214 the cloud node 1200 is configured to transmit the encoder model structure and the trained weights to the UE 902.

In an example embodiment, when the network is trained progressively, the cloud node 1200 may set Prog_Train=1, which informs the UE 902 about the option of using a single network for different CRs:
Prog_Train=0 means the ML model is trained in a traditional end to end scheme for a fixed CR. This means that the network cannot be used for several CRs.
Prog_Train=1 means that progressive training is used for training of the ML model, and it supports several CRS.

The Prog_Train=1 parameter may be sent to the UE 902 together with the CRs at 1210.

At 1216, the gNB 900 is configured to transmit to the UE 902 an indication of the CR to be used. At 1218, the UE 902 may be configured to estimate the CSI, and at 1220, compress the CSI using the first B blocks of the encoder. The parameter B is defined by the CR applied. At 1222, the UE 902 may be configured to transmit the compressed CSI to the gNB 900. At 1224, the gNB 900 may be configured to use the last B blocks of the decoder to reconstruct the CSI.

At some point of time, at 1226, the gNB 900 may be configured to select a new CR from the list of CRs. At 1228, the gNB 900 is configured to transmit to the UE 902 an indication of the new CR to be used. In an example embodiment, at 1230, the UE 902 may be configured to transmit an acknowledgement to the gNB 900. The acknowledgement confirms that the UE 902 has received all the necessary information and is ready to use the encoder. Instead of sending an explicit acknowledgement, the UE 902 may wait for a pre-defined time before using applying the new CR. At any point, if gNB 900 decides to change the CR, there is no need to share the network and its weights again, as the previous shared network can be used for the new CR. Thus, the gNB sends the required new number of encoder blocks, B_New, to the UE 902, and the UE 902 adapts the encoder active part accordingly.

At 1232, the UE 902 may be configured to estimate the CSI, and at 1234, compress the CSI using the first B_New blocks of the encoder. The parameter B_New is defined by the CR applied. At 1236, the UE 902 may be configured to transmit the compressed CSI to the gNB 900. At 1238, the gNB 900 may be configured to use the last B_New blocks of the decoder to reconstruct the CSI.

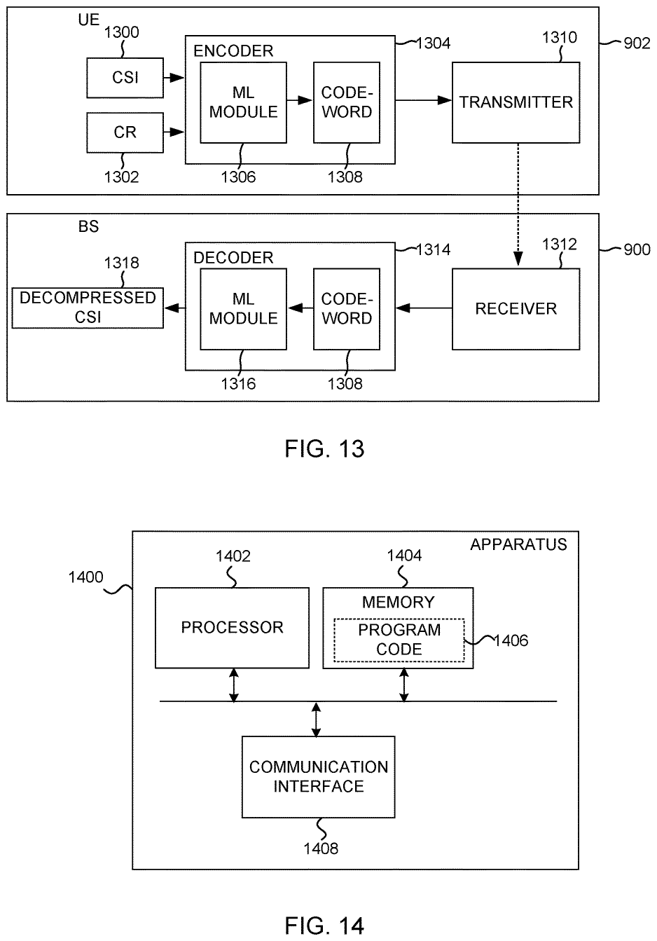

FIG. 13 illustrates a communication system applying a progressive growing autoencoder framework according to an example embodiment. For example, the communication system may include a UE 902 that may receive, for example, from a base station (BS) 900, a compression rate (CR) 1302 to be applied. The UE 902 may also estimate the downlink channel state information (CSI) 1300. As discussed in more detail in FIGS. 1, 2A and 2B and their description, an autoencoder may be trained progressively so that compression blocks of an encoder of an autoencoder and reconstruction blocks of a decoder of the autoencoder are trained progressively to provide a progressive growing autoencoder based on training data. The first block of an encoder and the last block of a decoder are trained to provide a first compression rate of the plurality of compression rates. Then, the remaining compression blocks of the encoder and the remaining reconstruction blocks of the decoder are subsequently progressively trained to provide respective remaining compression rates of the plurality of compression rates. In other words, the second block of the encoder and the second last block of the decoder are trained to provide a second compression rate of the plurality of compression rates. The procedure is continued until the last block of the encoder and the first block of the decoder have been trained to provide the last compression rate of the plurality of compression rates.

An encoder 1304 may compress the CSI 1300 with an ML module 1306 using the first B blocks of the encoder to provide a compressed CSI, i.e. a codeword 1308. The parameter B is defined by the CR used. The codeword 1308 may be transmitted to the BS 900 via a transmitter 1310.

As illustrated, the BS 900 may receive the codeword 1308 via a receiver 1312. The BS 900 may include a decoder 1314 having an ML module 1316 for decompressing the codeword 1308 and generating the decompressed (or reconstructed) codeword, i. e. the decompressed CSI 1318.

FIG. 14 illustrates an example of an apparatus 1400 configured to practice one or more example embodiments. The apparatus 1400 may comprise, for example, a base station, a gNB, a terminal apparatus, a user node, a user equipment, a cloud node or in general a device configured to implement the functionality described herein. Although the apparatus 1400 is illustrated as a single device, it is appreciated that, wherever applicable, functions of the apparatus 1400 may be distributed to a plurality of devices.

The apparatus 1400 may comprise at least one processor 1402. The at least one processor 1402 may comprise, for example, one or more of various processing devices or processor circuitry, such as, for example, a co-processor, a microprocessor, a controller, a Digital Signal Processor (DSP), a processing circuitry with or without an accompanying DSP, or various other processing devices including integrated circuits such as, for example, an Application Specific Integrated Circuit (ASIC), a Field Programmable Gate Array (FPGA), a Microcontroller Unit (MCU), a hardware accelerator, a special-purpose computer chip, or the like.

The apparatus 1400 may further comprise at least one memory 1404. The at least one memory 1404 may be configured to store, for example, computer program code or the like, for example, operating system software and application software. The at least one memory 1404 may comprise one or more volatile memory devices, one or more non-volatile memory devices, and/or a combination thereof. For example, the at least one memory 1404 may be embodied as magnetic storage devices (such as hard disk drives, solid state drives, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 1400 may further comprise a communication interface 1408 configured to enable the apparatus 1400 to transmit and/or receive information to/from other devices. In one example, the apparatus 1400 may use the communication interface 1408 to transmit or receive signaling information and data in accordance with at least one data communication or cellular communication protocol. The communication interface 1408 may be configured to provide at least one wireless radio connection, such as, for example, a 3GPP mobile broadband connection (e.g. 3G, 4G, 5G, 6G etc.). The communication interface 1408 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas. The communication interface 1408 may comprise a receiver, a transmitter or a transceiver.

When the apparatus 1400 is configured to implement some functionality, some component and/or components of the apparatus 1400, for example, the at least one processor 1402 and/or the at least one memory 1404, may be configured to implement this functionality. Furthermore, when the at least one processor 1402 is configured to implement some functionality, this functionality may be implemented using the program code 1406 comprised, for example, in the at least one memory 1404.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described herein. The program code 1406 is provided as an example of instructions which, when executed by the at least one processor 1402, cause performance of apparatus. Alternatively, or in addition, the functionality described herein can be performed, at least in part, by one or more hardware logic components. For example, and without limitation, illustrative types of hardware logic components that can be used include Field-programmable Gate Arrays (FPGAS), Application-Specific Integrated Circuits (ASICS), Application-Specific Standard Products (ASSPs), System-on-a-chip systems (SOCs), Complex Programmable Logic Devices (CPLDs), and Graphics Processing Units (GPUS).

The apparatus 1400 may be configured to perform or cause performance of any aspect of the method(s) described herein, for example, the functions executed by the UE or the gNB. Further, a computer program may comprise instructions for causing, when executed, an apparatus to perform any aspect of the method(s) described herein. The computer program may be stored on a computer-readable medium. Further, the apparatus 1400 may comprise means for performing any aspect of the method(s) described herein. In one example, the means may comprise the at least one processor 1402, the at least one memory 1404 including the program code 1406 (instructions) configured to, when executed by the at least one processor 1402, cause the apparatus 1400 to perform the method(s). In general, computer program instructions may be executed on means providing generic processing functions. The method(s) may be thus computer-implemented, for example based algorithm(s) executable by the generic processing functions, an example of which is the at least one processor 1402. The means may comprise transmission and/or reception means, for example one or more radio transmitters or receivers, which may be coupled or be configured to be coupled to one or more antennas, or transmitter(s) or receiver(s) of a wired communication interface.

One or more of the examples and example embodiments discussed above may enable a solution which can be used for any ML structure, like fully connected networks, FullyConv, or a network mixed of convolutional and fully connected layers. Further, one or more of the examples and example embodiments discussed above may enable a solution that allows for more depth network going to lower compression rates (smaller feedback sizes), which helps to guaranty the performance with small feedback sizes (low compression rates). Further, one or more of the examples and example embodiments discussed above may enable a solution that ensures well training of all the encoder and decoder layers while conventional training of the initial layers of an encoder may face problems due to vanishing gradients properties of backpropagation.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1-25. (canceled)

26. An apparatus comprising:
at least one processor; and
at least one memory storing instructions, that when executed by the at least one processor, cause the apparatus to perform:
obtaining training data;
obtaining a plurality of compression rates; and
training compression blocks of an encoder of an autoencoder and reconstruction blocks of a decoder of the autoencoder progressively to provide a progressive growing autoencoder based on the training data by training a first block of the encoder and a last block of the decoder to provide a first compression rate of the plurality of compression rates and then subsequently progressively training remaining compression blocks of the encoder and remaining reconstruction blocks of the decoder to provide respective remaining compression rates of the plurality of compression rates.

27. The apparatus according to claim 26, wherein the instructions, when executed by the at least one processor, cause the apparatus to perform:
transmitting, to a terminal apparatus, a model structure of the encoder, trained weights of the encoder, the plurality of compression rates and a required number of blocks for execution at each compression rate to enable the terminal apparatus to set an encoder model and to compress target data;
selecting a compression rate to be used; and
transmitting, to the terminal apparatus, an indication of the compression rate to be used.

28. The apparatus according to claim 27, wherein the instructions, when executed by the at least one processor, cause the apparatus to perform:
receiving, from the terminal apparatus, compressed target data associated with the compression rate to be used; and
decompressing the compressed target data using the reconstruction blocks of the decoder corresponding to the compression rate to be used to reconstruct the target data.

29. The apparatus according to claim 28, wherein the instructions, when executed by the at least one processor, cause the apparatus to perform:
selecting a new compression rate to be used;
transmitting, to the terminal apparatus, an indication of the new compression rate to be used;
receiving, from the terminal apparatus, new compressed target data associated with the new compression rate to be used; and
decompressing the new compressed target data associated with the new compression rate to be used using the reconstruction blocks of the decoder corresponding to the new compression rate to be used to reconstruct new target data.

30. The apparatus according to claim 26, wherein the instructions, when executed by the at least one processor, cause the apparatus to perform:
transmitting, to a base station, a model structure of the decoder, trained weights of the decoder, the plurality of compression rates and a required number of blocks for execution at each compression rate to enable the base station to set a decoder model and to decompress target data; and
receiving, from the base station, an indication of the compression rate to be used.

31. The apparatus according to claim 30, wherein the instructions, when executed by the at least one processor, cause the apparatus to perform:
obtaining target data to be compressed;
compressing the target data using the compression blocks of the encoder corresponding to the compression rate to be used to provide compressed target data; and
transmitting the compressed target data to the base station.

32. The apparatus according to claim 31, wherein the instructions, when executed by the at least one processor, cause the apparatus to perform:
receiving, from the base station, an indication of a new compression rate to be used;
obtaining new target data to be compressed;
compressing the new target data using the compression blocks of the encoder corresponding to the new compression rate to be used to provide new compressed target data; and
transmitting the new compressed target data to the base station.

33. A method comprising:
obtaining training data;
obtaining a plurality of compression rates; and
training compression blocks of an encoder of an autoencoder and reconstruction blocks of a decoder of the autoencoder progressively to provide a progressive growing autoencoder based on the training data by training a first block of the encoder and a last block of the decoder to provide a first compression rate of the plurality of compression rates and then subsequently progressively training remaining compression blocks of the encoder and remaining reconstruction blocks of the decoder to provide respective remaining compression rates of the plurality of compression rates.

34. The method according to claim 33, further comprising:
transmitting, to a terminal apparatus, a model structure of the encoder, trained weights of the encoder, the plurality of compression rates and a required number of blocks for execution at each compression rate to enable the terminal apparatus to set an encoder model and to compress target data;
selecting a compression rate to be used; and
transmitting, to the terminal apparatus, an indication of the compression rate to be used.

35. The method according to claim 34, further comprising:
receiving, from the terminal apparatus, compressed target data associated with the compression rate to be used; and
decompressing the compressed target data using the reconstruction blocks of the decoder corresponding to the compression rate to be used to reconstruct the target data.

36. The method according to claim 35, further comprising:
selecting a new compression rate to be used;
transmitting, to the terminal apparatus, an indication of the new compression rate to be used;
receiving, from the terminal apparatus, new compressed target data associated with the new compression rate to be used; and
decompressing the new compressed target data associated with the new compression rate to be used using the reconstruction blocks of the decoder corresponding to the new compression rate to be used to reconstruct new target data.

37. The method according to claim 33, further comprising:
transmitting, to a base station, a model structure of the decoder, trained weights of the decoder, the plurality of compression rates and a required number of blocks for execution at each compression rate to enable the base station to set a decoder model and to decompress target data; and
receiving, from the base station, an indication of the compression rate to be used.

38. The method according to claim 37, further comprising:
obtaining target data to be compressed;
compressing the target data using the compression blocks of the encoder corresponding to the compression rate to be used to provide compressed target data; and
transmitting the compressed target data to the base station.

39. The method according to claim 38, further comprising:
receiving, from the base station, an indication of a new compression rate to be used;
obtaining new target data to be compressed;
compressing the new target data using the compression blocks of the encoder corresponding to the new compression rate to be used to provide new compressed target data; and
transmitting the new compressed target data to the base station.

40. An apparatus comprising:
at least one processor; and
at least one memory storing instructions, that when executed by the at least one processor, cause the apparatus to perform:
receiving a model structure of an encoder, trained weights of the encoder, a plurality of compression rates and a required number of compression blocks for execution at each compression rate;
receiving, from a base station, an indication of a compression rate to be used; and
setting an encoder model of the encoder based on the model structure of the encoder, the trained weights of the encoder, the plurality of compression rates and the required number of compression blocks for execution at each compression rate.

41. The apparatus according to claim 40, wherein the instructions, when executed by the at least one processor, cause the apparatus to perform:
obtaining target data to be compressed;
compressing the target data using the compression blocks of the encoder corresponding to the compression rate to be used to provide compressed target data; and
transmitting the compressed target data to the base station.

42. The apparatus according to claim 40, wherein the instructions, when executed by the at least one processor, cause the apparatus to perform:
transmitting, to a base station, a model structure of a decoder, trained weights of the decoder, a plurality of compression rates and a required number of reconstruction blocks for execution by the base station at each compression rate.

43. The apparatus according to claim 42, wherein the instructions, when executed by the at least one processor, cause the apparatus to perform:
transmitting, to the base station, compressed target data associated with the compression rate to be used for decompression, by the base station, of the compressed target data using the reconstruction blocks of the decoder corresponding to the compression rate to be used to reconstruct the target data.
